(19) United States
(12) Patent Application Publication
(10) Pub. No.: US 2006/0274333 A1
(43) Pub. Date: Dec. 7, 2006

(54) Image forming device

(75) Inventor: In-cheol Jeon, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/358,154

(22) Filed: Feb. 22, 2006

(30) Foreign Application Priority Data
Jun. 1, 2005 (KR) 10-2005-0046654

(51) Int. Cl. G06K 15/12

(52) U.S. Cl. 358/1.7

(57) ABSTRACT

An image forming device has a radiation element for emitting a light, a mirror motor for reflecting the light emitted from the radiation element, a lens for focusing and irradiating the reflected light to the photosensitive drum, and a light exposure unit including a first and a second control modules for controlling an energy of the light emitted from the radiation element for each light exposure unit. Therefore, the variation of development density can be minimized.

### CROSS-REFERENCE TO RELATED APPLICATIONS

This application claims the benefit of Korean Patent Application No. 2005-46654 filed on Jun. 1, 2005, in the Korean Intellectual Property Office, the disclosure of which is hereby incorporated by reference in its entirety.

### BACKGROUND OF THE INVENTION

1. Field of the Invention

The present invention relates to an image forming device. More particularly, the present invention relates to an image forming device, which can minimize a variation of the development density generated in opposite edges and in a middle portion of a printed document.

2. Description of the Related Art

Generally, a Laser Beam Printer, a LPH (LED Print Head) printer, and a facsimile include an image forming device. The image forming device performs printing by the process of charging, scanning, developing, transferring, and fixing.

The image forming device comprises a photosensitive drum charged with a high-voltage by a charged roller, a light exposure part for forming an electrostatic latent image, a developing unit for converting the electrostatic latent image into a visible image, a transfer unit for transferring the visible image onto a front page of a paper, and a fixing unit for fixing the toner transferred onto the paper.

If the image forming device with the above structure is applied, the middle portion of the image has a high-density, and opposite ends of the image have a low-density. The above may be caused by various reasons. One representative reason is explained below.

FIG. 1 is a schematic view of a photosensitive drum and a developing roller of a conventional image forming device. Referring to FIG. 1, an example of the reasons for the irregular development density are described.

A photosensitive drum 10 and a development roller 20 maintain a regular interval therebetween by an interval maintenance member 22. Ideally, the photosensitive drum 10 is provided in parallel with the development roller 20. However, this arrangement is impossible.

As shown in FIG. 1, if the axis of the photosensitive drum 10 and the axis of the development roller 20 are not parallel, the space between both middle portions become closer, while the space between the opposite ends increase. In jumping, the space between the photosensitive drum 10 and the developing roller 20 exert a direct influence on a developing capacity. In particular, the variation of space of more than 20 μm directly results in the variation of density of the image.

FIG. 2 is a graph of the relation between light exposure potential and energy. Referring to FIG. 2, another example of the representative reason of the irregular development of the density is described which occurs by the light exposure unit.

An example of the light exposure unit is a LSU (Laser Scanning Unit). As the radiation element emits a laser beam, the laser beam is reflected by a high-speed mirror motor and passes though a lens to expose the photosensitive drum 10 and to form an electrostatic latent image.

The radiation element is controlled by a control unit for controlling the time and energy level. If one lens is employed, a light exposure unit formed on the photosensitive drum 10 is provided in a substantial circular form at a middle portion, and an elliptic form is formed at the opposite ends. In other words, the area of the light exposure unit of the middle portion is smaller than that of the light exposure unit at the opposite ends of the drum, and therefore, the energy per area is comparatively high in the middle portion. Accordingly, the variation of the light exposure potential occurs as shown in FIG. 2, which directly results in the variation of the development density between the middle portion and the opposite ends. More particularly, the photosensitive drum 10 has a surface potential by the charged roller, and then the light exposure potential by the light exposure part. A developer is moved to the light exposure potential on the photosensitive drum 10 and developed by a developing potential of the development roller 20. The amount of movement of the developer is greatly influenced by the potential difference. In other words, as the difference between the developing potential and the light exposure potential increases, the greater the amount of developer is moved. The difference of the light exposure potential between the middle portion and the opposite ends that occur by the difference of the areas of the light exposure unit is an important factor in the difference of the development density.

Accordingly, it is necessary to minimize the various factors that cause the difference between density at the middle portion and the opposite ends of the image caused by the structure of the image forming device

### SUMMARY OF THE INVENTION

Accordingly, the present invention overcomes the above problem and/or advantages and to provide at least the advantages described below. Therefore, one aspect of the present invention is to provide an image forming device which controls an energy level of a radiation element of a light exposure unit using a pair of control modules connected in parallel so that variations of development density can be reduced.

According to an aspect of the present invention, an image forming device comprises a radiation element emitting a light, a mirror motor for reflecting the light emitted from the radiation element, a lens for focusing and irradiating the reflected light to the photosensitive drum, and a light exposure unit including first and second control modules for controlling an energy of the light emitted from the radiation element for each light exposure unit.

The first and the second control modules may be connected in parallel with each other.

The first and the second control modules may control the energy of the light to alternatively arrange each light exposure unit with each different energy at opposite ends of the photosensitive drum.

The first and the second control modules may change an alternative arrangement cycle of the energy of the light to control the energy of the light.

The radiation element may comprise a laser diode.

These and other features of the invention will become apparent from the following detailed description of the invention which, taken in conjunction with the annexed drawings, disclose various embodiments of the invention.

### BRIEF DESCRIPTION OF THE DRAWINGS

The above aspects and features of the present invention will be more apparent by describing certain embodiments of the present invention with reference to the accompanying drawings, in which:

FIG. 1 is a schematic view of a photosensitive drum and a development roller of a general image forming device;

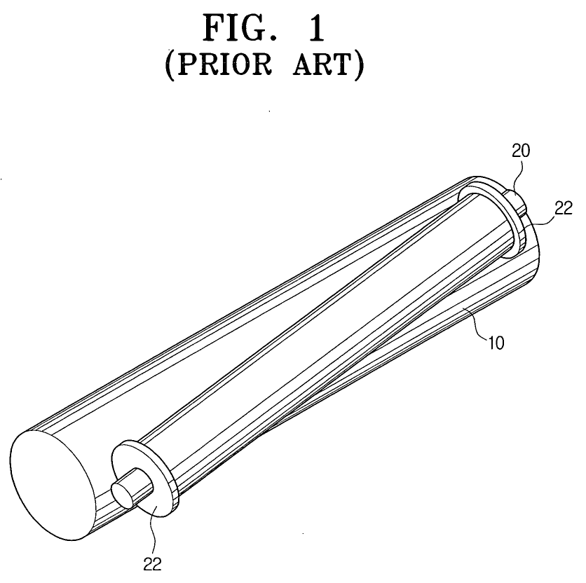

FIG. 2 is a graph of the relationship between the light exposure potential and the energy of a conventional image forming device;

FIG. 3 is a schematic view of an image forming device according to an embodiment of the present invention;

FIG. 4 is a schematic view of a light exposure unit according to an embodiment of the present invention; and

FIGS. 5A to 5B are graphs of the relationship between the light exposure potential and the energy of an image forming device according to an embodiment of the present invention.

### DETAILED DESCRIPTION OF THE EXEMPLARY EMBODIMENTS

Exemplary embodiments of the present invention are described in detail with reference to the annexed drawings. In the drawings, the same elements are denoted by the same reference numerals throughout the drawings. In the following, detailed descriptions of known functions and configurations incorporated herein have been omitted for conciseness and clarity.

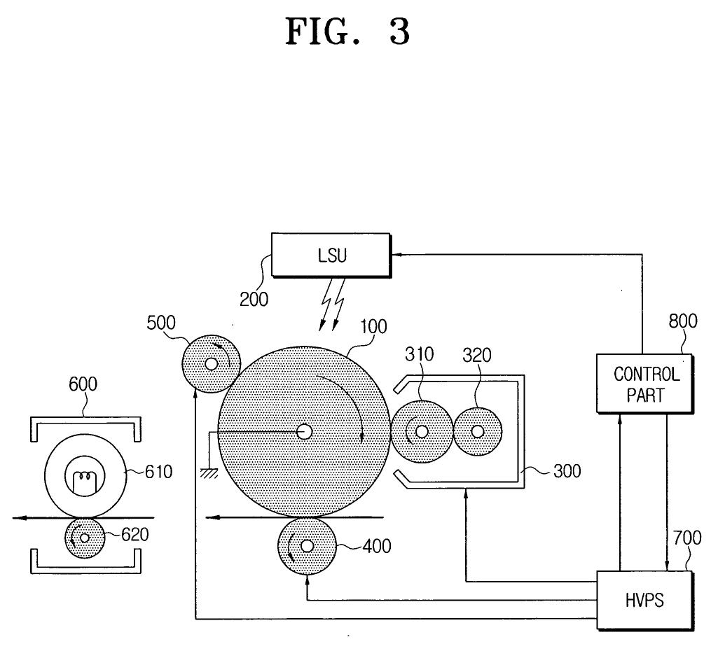

FIG. 3 is a schematic view of an image forming device according to an embodiment of the present invention.

Referring to FIG. 3, the image forming device according to an embodiment of the present invention comprises a photosensitive drum 100, a light exposure unit 200, a developing unit 300, a transfer roller 400, a charged roller 500, a fixing roller assembly 600, a HVPS (high voltage power supply) 700, and a control part or unit 800.

The photosensitive drum 100 may be an OPC (organic photo-conductive) drum. The surface of the photosensitive drum 100 is charged with a regular high-voltage by the charged roller 500 and imaged by light prior to the image being printed onto a paper.

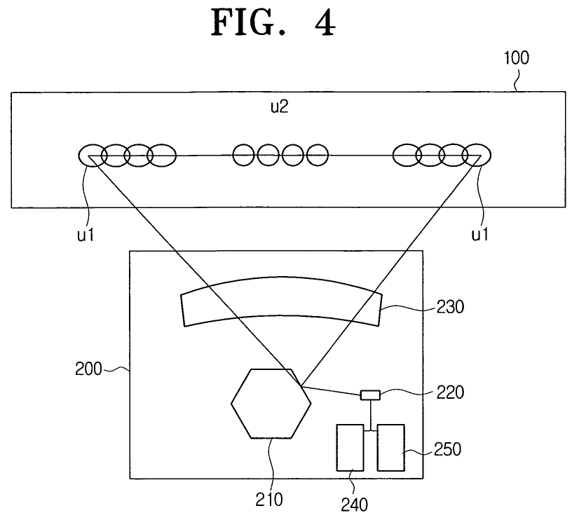

The light exposure unit 200 may be a light scanner or LSU (laser scanning unit), and emits a light on the photosensitive drum 100 to form a latent image. The latent image formed on the surface of the photosensitive drum 100 by the light exposure unit 200 is an electrostatic latent image. The light exposure unit 200 is described herein with reference to FIG. 4.

The developing unit 300 converts the electrostatic latent image formed on the surface of the photosensitive drum 100 into a visible image by transferring developer particles such as toner to the drum and to the latent image. The developing unit 300 comprises a development roller 310 and a supply roller 320.

The developing roller 310 develops the electrostatic latent image formed on the photosensitive drum 100 by the light exposure unit 200 with the toner. In other words, as the potential difference occurs between the supply roller 320 having a certain supply voltage and the developing roller 310 having a certain development voltage, the toner is transferred from the supply roller 320 to the developing roller 310. Accordingly, a toner image is formed on a portion of the photosensitive drum 100 where the electrostatic latent image is formed.

Rotating the transfer roller 400 in contact with the photosensitive drum 100 having the transfer voltage supplied from the HVPS 700, enables the transfer roller 400 to transfer a developed image from the photosensitive drum 100 to a print paper passing between the transfer roller 400 and the photosensitive drum 100.

The charged roller 500 charges the photosensitive drum 100 with a predetermined charged voltage supplied from the HVPS 700.

The fixing unit 600 fixes the transferred toner image onto the print paper with a high temperature and pressure. As the fixing is completed, the print paper is discharged along a discharge direction (arrow direction) to the outside to complete the printing process. The fixing part 600 comprises a fixing roller 610 and a pressure roller 620. The fixing roller 610 heats the toner particles, and the pressure roller 620 pressurizes the toner particles.

The HVPS 700 supplies each roller of the image forming device with a certain voltage under the control of the control unit 800. In other words, the HVPS 700 supplies the charged roller 500, the developing roller 310, the supply roller 320, and the transfer roller 400 with a certain charged voltage, developing voltage, supply voltage, and transfer voltage, respectively.

The control unit 800 controls general operations of the image forming device to perform printing.

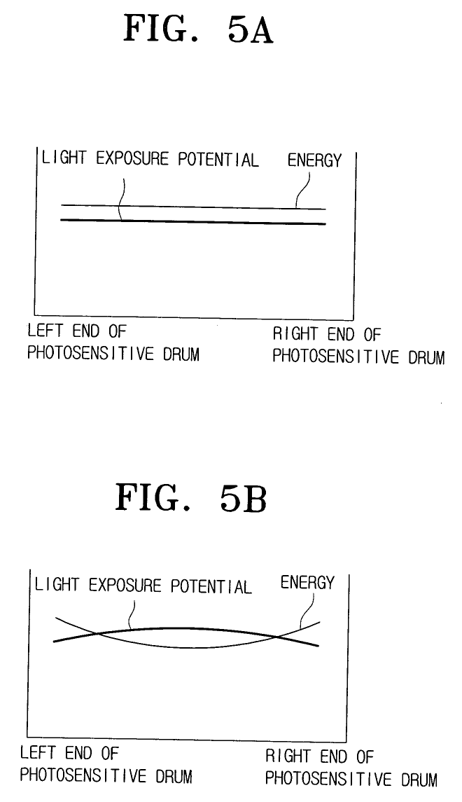

FIG. 4 is a schematic view of the light exposure part according to an embodiment of the present invention. FIGS. 5A to 5B are graphs of the relationship between the light exposure potential and the energy of the image forming device according to an embodiment of the present invention.

Referring to FIG. 4, the light exposure part 200 according to an embodiment of the present invention comprises a mirror motor 210, a radiation element 220, a lens 230, a first control module 240, and a second control module 250.

The mirror motor 210 rotates at a high speed and reflects the light emitted from the radiation element 220 to the lens 230.

The radiation element 220 emits the light to be irradiated to the photosensitive drum 100 and employs a laser diode.

The lens 230 focuses and irradiates the light to the photosensitive drum 100 as the light is emitted from the radiation element 220 and reflected by the mirror motor 210.

The first control module 240 controls the energy level of light emitted from the radiation element 220 and is connected with the second control module 250 in parallel to control the energy of light, independently of the second control module 250.

The second control module 250 controls the energy level of the light emitted from the radiation element 220 in the same manner as the first control module 240. The second control module 250 is connected with the first control module 240 in parallel to control the energy of light, independently of the first control module 240.

As the light is emitted from the radiation element 220 and reflected by the mirror motor 210, the reflected light passes through the lens 230 and is irradiated to the photosensitive drum 100. At this time, the position of the light irradiated onto the photosensitive drum 100 and exposed is indicated by light exposure units U1 and U2. The light exposure units formed at opposite ends and a middle portion of the photosensitive drum 100 are identified by U1 and U2, respectively.

As shown, when one lens 230 is employed, the light exposure unit U2 at the middle portion of the photosensitive drum 100 is provided in a circular form, and the light exposure unit U1 at opposite ends of the photosensitive drum 100 is provided in an elliptical form. Since the area of the light exposure unit U2 formed at the middle portion is smaller than that of the light exposure unit U1 formed at opposite ends, a variation of the light exposure occurs due to the difference between the energy in each area.

To solve the above variation of the light exposure, the first and the second control modules 240, 250 control the energy of the light emitted from the radiation element 220 so that the light exposure units U1 formed at opposite ends of the photosensitive drum 100 are alternatively arranged with each different energy.

If the first and the second control modules 240, 250 control the energy of the light to be alternatively arranged with each different energy as the energy of the light emitted from the radiation element 220 is irradiated to the opposite ends of the photosensitive drum 100, the light exposure potential can be obtained as shown in the graph of FIG. 5A.

Referring FIG. 5A, as the light exposure units U1, U2 are alternatively arranged with each different energy, the energy and the light exposure can be controlled to be uniform and constant along the length of the photosensitive drum, irrespective of the opposite ends and the middle portion of the photosensitive drum 100. In this manner, the control modules compensate for variations in the orientation of the developing roller with respect to the developing drum and to prevent variations in the image density of the toner.

Additionally, controlling the light exposure units U1, U2 to be alternatively arranged with each different energy at the opposite ends of the photosensitive drum 100, the first and the second control modules 240, 250 changes the alternative arrangement cycle to be irregular so as to control the energy of the light emitted from the radiation element 220.

If the first and the second control modules 240, 250 change the alternative arrangement cycle to be irregular as the energy of light emitted from the radiation element 220 is irradiated to the opposite ends of the photosensitive drum 100 and the light exposure units are alternatively arranged with each different energy, the light exposure potential can be obtained as shown in the graph of FIG. 5B.

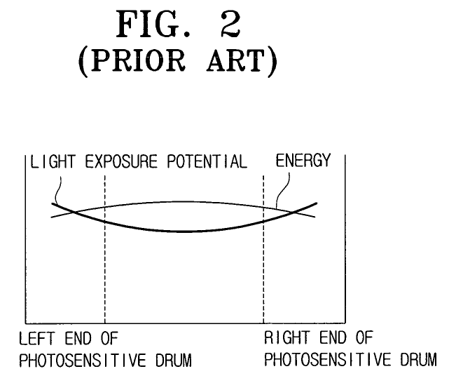

In FIG. 5B, the energy of the light exposure unit U1 formed at a left end of the photosensitive drum 100 decreases to increase the light exposure potential, and the energy of the light exposure unit U1 formed at a right end of the photosensitive drum 100 increases to decrease the light exposure potential. In FIG. 2, the same energy is applied to one page of the print paper. However, referring to FIG. 5, it is possible to control and to apply each different energy to the light exposure units U1, U2, respectively, so that the variation of the light exposure potential can be arbitrarily changed.

The printing process of the image forming device according to an exemplary embodiment of the present invention is described as follows. The photosensitive drum 100 is charged by the charged roller 500 to form the surface potential and form the electrostatic latent image by the light exposure unit 200. As forming the electrostatic latent image by the light exposure unit 200, each light exposure unit U1, U2 has a different energy determined by the first and the second control module 240, 250.

As the developer is supplied by the supply roller 320 of the developing unit 300, the developer layer is regulated by the developing roller 310. The developing roller develops the electrostatic latent image into a visible image and the transfer roller 400 transfers the visible image onto the print paper. Then, the fixing roller 610 and the pressure roller 620 fuse the toner consisting of the visible image to fix the image onto the print paper.

As described above, if the image forming device according to an embodiment of the present invention is applied, two control modules connected in parallel with each other control the energy of light emitted from the radiation element, respectively, so that the variation of development density can be minimized which occurs at the middle portion and the opposite ends of the print paper.

While the invention has been shown and described with reference to certain embodiments thereof, it will be understood by those skilled in the art that various changes in form and details may be made therein without departing from the spirit and scope of the invention as defined by the appended claims.

What is claimed is:

1. An image forming device including a light exposure unit for forming an electrostatic latent image on a surface of a photosensitive drum, wherein the light exposure unit comprises:
a radiation element for emitting a light;
a mirror motor for reflecting the light emitted from the radiation element;
a lens for focusing and irradiating the reflected light to the photosensitive drum; and
a first and a second control module for controlling an energy of the light emitted from the radiation element for each light exposure unit.

2. The device as claimed in claim 1, wherein the first and the second control modules are connected in parallel with each other.

3. The device as claimed in claim 1, wherein the first and the second control modules control the energy of the light to alternatively arrange each light exposure unit with different energies at opposite ends of the photosensitive drum.

4. The device as claimed in claim 3, wherein the first and the second control modules provide an alternative arrangement cycle of the energy of the light to control the energy of the light.

5. The device as claimed in claim 1, wherein the radiation element comprises a laser diode.
